(19) United States
(12) Patent Application Publication
(10) Pub. No.: US 2012/0029153 A1
(43) Pub. Date: Feb. 2, 2012

(54) ADHESIVE AND MANUFACTURING METHOD THEREOF

(76) Inventor: Hsin-Wei CHEN, Chiayi County (TW)

(21) Appl. No.: 13/042,998

(22) Filed: Mar. 8, 2011

(30) Foreign Application Priority Data
Jul. 30, 2010 (TW) 099125295

(51) Int. Cl. C09J 133/14

(52) U.S. Cl. 525/194; 525/223

(57) ABSTRACT

An adhesive and a manufacture method thereof are provided. The adhesive is made by crosslinking a first polymer with a second polymer. The glass transition temperature of the first polymer is higher than the glass transition temperature of the second polymer. The first polymer and the second polymer are miscible in each other.

### BACKGROUND OF THE INVENTION

1. Field of the Invention

This invention generally relates to an adhesive and a manufacturing method thereof. More particularly, this invention relates to an adhesive for optical films and a manufacturing method thereof.

2. Description of the Prior Art

In general, optical films of different functions are laminated and employed in display devices such as liquid crystal display device or plasma display device, wherein the optical films include polarizer (TAC), phase retardation film, EMI shielding film, anti-glare film, and anti-reflection film, etc. Protection films are generally adhered to the surfaces of the optical films to prevent the optical films from being damaged in manufacturing processes or inspection steps, and the protection films will be removed during the formation of laminated films or the assembly of display panels. Therefore, the protection film must be transparent so that it does not cause interference in the inspection process, and the adhesion thereof allows substantially no bubbles in the laminated film. In addition, the adhesion between the protection film and the adhered object should maintain constant, and there should be substantially no residual adhesive left on the surfaces of the adhered object after the protection film is removed.

The adhesion of the adhesive for the protection film is lower than the adhesion of conventional adhesives since the protection film is designed to be removed. For polymers with high glass transition temperature (Tg), the high Tg t makes the polymers remain little adhesion at low temperature. As for the polymers with low Tg, of which the retention is insufficient due to the low modulus.

### SUMMARY OF THE INVENTION

The present invention is to provide an adhesive and a manufacturing method thereof, wherein the adhesive has higher modulus variation.

The adhesive is made by crosslinking a first polymer and a second polymer with a crosslink agent, wherein the glass transition temperature of the first polymer is higher than the glass transition temperature of the second polymer. The first polymer and the second polymer are miscible in each other.

In a preferred embodiment, the glass transition temperature of the first polymer is between 30° C. and 85° C., while the glass transition temperature of the second polymer is between −60° C. and −20° C. The first polymer and the second polymer are methyl acrylate polymers. The weight percentage of the first polymer is between 1% and 20%. The weight percentage of the second polymer is between 99% and 80%. The crosslink agent for crosslinking the first polymer and the second polymer is isocyanate.

The adhesive manufacturing method includes the following steps: providing a first polymer, providing a second polymer, and crosslinking the first polymer and the second polymer, wherein the glass transition temperature of the first polymer is higher than the glass transition temperature of the second polymer, and the first polymer and the second polymer are miscible in each other.

### BRIEF DESCRIPTION OF THE DRAWINGS

FIG. 1 is an embodiment of the present invention.

### DETAILED DESCRIPTION OF THE PREFERRED EMBODIMENT

The adhesive of the present invention is made by crosslinking a first polymer and a second polymer, wherein the glass transition temperature (Tg) of the first polymer is higher than the Tg of the second polymer; the first polymer and the second polymer are miscible in each other.

The first polymer is preferably methyl acrylate polymer. More particularly, methyl acrylate monomer having number of carbon in the alkyl group between 1 and 12, such as methyl methacrylate, ethyl methacrylate, n-butyl methacrylate, 1-methylpropyl methacrylate, dimethylethyl methacrylate, isobutyl methacrylate, n-hexyl methacrylate, 2-ethylhexyl methacrylate, n-octyl methacrylate, isooctyl methacrylate, n-nonyl methacrylate, isononyl methacrylate, n-decyl methacrylate, isodecyl methacrylate, n-dodecyl methacrylate, or a similar one can be used. The weight percentage of the first polymer is between 0.5% and 50% and is preferably between 1% and 20%. The average molecular weight of the first polymer is between 100,000 and 5,000,000 and is preferably between 500,000 and 2,000,000. The weight percentage of the second polymer is between 99.5% and 50% and is preferably between 99% and 80%. The average molecular weight of the second polymer is between 2,000 and 800,000 and is preferably between 200,000 and 400,000.

The first polymer is preferably but not limited to crosslink with the second polymer by using isocyanate as the crosslink agent. The polymerization method can be solution polymerization, emulsion polymerization, suspension polymerization, or bulk polymerization. The glass transition temperature of the first polymer is between 0 and 150° C., preferably between 10° C. and 100° C., and more preferably between 30° C. and 85° C. The glass transition temperature of the second polymer is between −100° C. and 0, preferably between −80° C. and −10° C., and more preferably between −60° C. and −20° C.

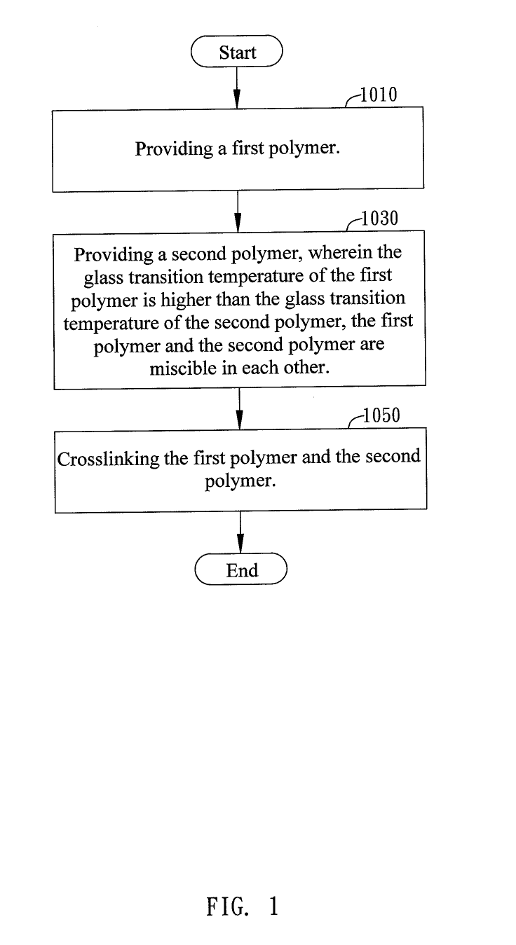

As shown in FIG. 1, the adhesive manufacturing method of the present invention includes the following steps: step 1010 of providing the above mentioned first polymer; step 1030 of providing the above mentioned second polymer, wherein the glass transition temperature of the first polymer is higher than the glass transition temperature of the second polymer, the first polymer and the second polymer are miscible in each other; and step 1050 of crosslinking the first polymer and the second polymer.

The effect of the adhesive of the present invention is illustrated in the following different embodiments, wherein the products in embodiment A to embodiment D are used as raw materials in a comparison example and embodiment 1 to embodiment 5.

### Embodiment A

98.5 weight parts of n-butyl methacrylate (n-BA), 1.0 weight parts of acrylic acid (AA), 0.5 weight parts of hydroxyethyl methacrylate (HEMA), 150 weight parts of ethyl acetate, and 0.06 weight parts of azobisisobutyronitrile (AIBN) are put in a four-neck reactor. After the reactor is purged with nitrogen, the temperature of the reaction solution is raised to 60° C., and the reaction solution is stirred under nitrogen and allowed to react for 8 hours. After the reaction is completed, the solution in the reactor is diluted with ethyl acetate to obtain an acrylate copolymer solution with a solid content of 20%. The Mw (average molecular weight) of the acrylate copolymer solution is measured as 1,500,000 by a GPC apparatus (600 Controller, Waters Corp.). The measuring conditions include: taking a 0.2 wt % tetrahydrofuran (THF) solution as the testing sample, wherein 200 μL of the testing sample is injected; taking a tetrahydrofuran solution as an eluent; taking Shodex KF803, Shodex KF804, Shodex KF805, and Shodex KF806 as columns 1, 2, 3, and 4, taking refractive index detector as the detector; and obtaining the Mw in accordance with polystyrene.

### Embodiment B

60 weight parts of t-butyl methacrylate (t-BMA), 20 weight parts of n-butyl methacrylate, 10 weight parts of acrylic acid, 10 weight parts of hydroxyethyl methacrylate, 150 weight parts of acetone, and 0.06 weight parts of azobisisobutyronitrile are put in a four-neck reactor. After the reactor is purged with nitrogen, the temperature of the reaction solution is raised to the reflux temperature (a reflux temperature is the boiling point of the solvent used, for example, the boiling point of acetone is 57° C.), and the reaction solution is stirred under nitrogen and allowed to react for 12 hours. After the reaction is completed, the solution in the reactor is diluted with ethyl acetate to obtain an acrylate copolymer solution with a solid content of 20%. The Mw of the acrylate copolymer solution is measured as 400,00 by the GPC apparatus. The glass transition temperature of the acrylate copolymer solution is measured as 61.3° C. by a DSC apparatus (DCS Q100, TA instruments).

### Embodiment C

45 weight parts of t-butyl methacrylate, 35 weight parts of n-butyl methacrylate, 10 weight parts of acrylic acid, 10 weight parts of hydroxyethyl methacrylate, 150 weight parts of acetone, and 0.5 weight parts of azobisisobutyronitrile are put in a four-neck reactor. After the reactor is purged with nitrogen, the temperature of the reaction solution is raised to the reflux temperature, and the reaction solution is stirred under nitrogen and allowed to react for 12 hours. After the reaction is completed, the solution in the reactor is diluted with ethyl acetate to obtain an acrylate copolymer solution with a solid content of 20%. The Mw of the acrylate copolymer solution is measured as 400,000 by the GPC apparatus. The glass transition temperature of the acrylate copolymer solution is measured as 30.7° C. by the DSC apparatus.

### Embodiment D

68 weight parts of t-butyl methacrylate, 12 weight parts of n-butyl methacrylate, 10 weight parts of acrylic acid, 10 weight parts of hydroxyethyl methacrylate, 150 weight parts of acetone, and 0.5 weight parts of azobisisobutyronitrile are put in a four-neck reactor. After the reactor is purged with nitrogen, the temperature of the reaction solution is raised to the reflux temperature, and the reaction solution is stirred under nitrogen and allowed to react for 12 hours. After the reaction is completed, the solution in the reactor is diluted with ethyl acetate to obtain an acrylate copolymer solution with a solid content of 20%. The Mw of the acrylate copolymer solution is measured as 400,000 by the GPC apparatus. The glass transition temperature of the acrylate copolymer solution is measured as 80.3° C. by the DSC apparatus.

The weight percentages of the polymers in embodiments A to D are listed in table 1. In embodiments A to D, the second polymer is formed as in embodiment A and the first polymer is formed as in embodiments B, C, and D.

TABLE 1

| | Wt % | | | | | Tg |
|---|---|---|---|---|---|---|
| | n-BA | t-BMA | AA | HEMA | Mw | (° C.) |
| EMBODIMENT A | 98.5 | 0 | 1.5 | 0.5 | 1,500,000 | −52.6 |
| EMBODIMENT B | 20 | 60 | 10 | 10 | 400,000 | 61.3 |
| EMBODIMENT C | 35 | 45 | 10 | 10 | 400,000 | 30.7 |
| EMBODIMENT D | 12 | 68 | 10 | 10 | 400,000 | 80.3 |

### Comparasion Example

100 weight parts of acrylate copolymer solution with a solid content of 20% from embodiment A is added and fully mixed with 0.15 weight parts of isocyanate crosslink agent (AD-75, ANFONG COMPANY, TAIWAN), and an adhesive is obtained. The obtained adhesive is applied onto a releasing-treated PET film and dried at 90° C. for 3 minutes. After the solvent is evaporated, the as-formed adhesive layer is then cured at 50° C. for 20 hours to be a test sample.

### Embodiment 1

100 weight parts of acrylate copolymer solution with a solid content of 20% from embodiment A is added and fully mixed with 10 weight parts of the product from embodiment B and 0.15 weight parts of isocyanate crosslink agent, and an adhesive is obtained. The obtained adhesive is applied onto a releasing-treated PET film and dried at 90° C. for 3 minutes. After the solvent is evaporated, the as-formed adhesive layer is then cured at 50° C. for 20 hours to be a test sample.

### Embodiment 2

100 weight parts of acrylate copolymer solution with a solid content of 20% from embodiment A is added and fully mixed with 5 weight parts of the product from embodiment B and 0.15 weight parts of isocyanate crosslink agent, and an adhesive is obtained. The obtained adhesive is applied onto a releasing-treated PET film and dried at 90° C. for 3 minutes. After the solvent is evaporated, the as-formed adhesive layer is then cured at 50° C. for 20 hours to be a test sample.

### Embodiment 3

100 weight parts of acrylate copolymer solution with a solid content of 20% from embodiment A is added and fully mixed with 1.0 weight parts of the product from embodiment B and 0.15 weight parts of isocyanate crosslink agent, and an adhesive is obtained. The obtained adhesive is applied onto a releasing-treated PET film and dried at 90° C. for 3 minutes. After the solvent is evaporated, the as-formed adhesive layer is then cured at 50° C. for 20 hours to be a test sample.

### Embodiment 4

100 weight parts of acrylate copolymer solution with a solid content of 20% from embodiment A is added and fully mixed with 10 weight parts of the product from embodiment C and 0.15 weight parts of isocyanate crosslink agent, and an adhesive is obtained. The obtained adhesive is applied onto a releasing-treated PET film and dried at 90° C. for 3 minutes. After the solvent is evaporated, the as-formed adhesive layer is then cured at 50° C. for 20 hours to be a test sample.

### Embodiment 5

100 weight parts of acrylate copolymer solution with a solid content of 20% from embodiment A is added and fully mixed with 10 weight parts of the product from embodiment D and 0.15 weight parts of isocyanate crosslink agent, and an adhesive is obtained. The obtained adhesive is applied onto a releasing-treated PET film and dried at 90° C. for 3 minutes. After the solvent is evaporated, the as-formed adhesive layer is then cured at 50° C. for 20 hours to be a test sample.

The compositions of the adhesives in the comparison example and the embodiments 1 to 5 are listed in table 2.

TABLE 2

| | EMBODIMENT A | EMBODIMENT B | EMBODIMENT C | EMBODIMENT D |
|---|---|---|---|---|
| COMPARISON | 100 | 0 | 0 | 0 |
| EXAMPLE | | | | |
| EMBODIMENT 1 | 100 | 10 | 0 | 0 |
| EMBODIMENT 2 | 100 | 5 | 0 | 0 |
| EMBODIMENT 3 | 100 | 1 | 0 | 0 |
| EMBODIMENT 4 | 100 | 0 | 10 | 0 |
| EMBODIMENT 5 | 100 | 0 | 0 | 10 |

Adhesion test, retention test and storage modulus test are performed onto the adhesive samples of the comparison example and the embodiments 1 to 5. The adhesion test is performed by a tensile strength tester (Dachang, Cometech Testing Machines Co., Ltd, Taiwan), wherein a PET film coated with the adhesive is cut to a long narrow strip having a width of 2.5 cm, run over by a 2 kg roller to make the adhesive face be attached to a surface of a SUS316 standard copper plate, and measured a 180° adhesive force between the adhesive face and the copper plate by the tensile strength tester with a pulling speed of 300 mm/min under 3±1° C./50±2% RH environment.

Regarding to the retention test, a PET film coated with the adhesive is cut to a long narrow strip having a width of 2.5 cm, run over by a 2 kg roller to make the adhesive face be attached to the surface of the SUS316 standard copper plate within an area of 2.5 mm×2.5 mm, and placed in a 70° C. oven for 20 minutes. The resulting sample is then hung with a 1 kg weight for 40 minutes. The retention regards to the time period from hanging the 1 kg weight until it falling off, or a displacement (in mm) of the strip for holding the 1 kg weight for 40 minutes.

The storage modulus test is performed by a rheometer (AR2000ex, TA instruments), wherein 25 mm diameter plates are used. The spacing is 1 mm, the stress is 2000 Pa, the frequency is 10 Hz, and the temperature is between 25° C. and 100° C.

The properties of the adhesive in the comparison example and embodiments 1 to 5 are listed in table 3.

TABLE 3

| | adhesion | retention | G′ | G′ | G′(30° C.)/ |
|---|---|---|---|---|---|
| | (gf/25 mm) | (mm) | (30° C.)(Pa) | (80° C.)(Pa) | G′(80° C.) |
| COMPARISON | 1200 | 0 | 119500 | 97700 | 1.22 |
| EXAMPLE | | | | | |
| EMBODIMENT 1 | 500 | 0 | 205800 | 105700 | 1.95 |
| EMBODIMENT 2 | 1000 | 0 | 156200 | 98400 | 1.59 |
| EMBODIMENT 3 | 1200 | 0 | 123800 | 97200 | 1.27 |
| EMBODIMENT 4 | 1000 | 0 | 145500 | 96800 | 1.50 |
| EMBODIMENT 5 | 800 | 0 | 169700 | 114800 | 1.48 |

As shown in table 3, the 30° C. storage modulus (G′) of the embodiments 1 to 5 containing high glass transition temperature (30° C.˜80° C.) material are higher than the 30° C. storage modulus (G′) of the comparison example without high glass transition temperature material contained therein, wherein there is no significant difference between the 80° C. storage modulus of the embodiments 1 to 5 containing high glass transition temperature material and the 80° C. storage modulus (G′) of the comparison example without high glass transition temperature material contained therein. In other words, the adhesive of the present invention made by crosslinking the first polymer with a higher glass transition temperature and the second polymer with a lower glass transition temperature has higher storage Modulus variation along with the temperature cariation, better adhesion, and better retention.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. An adhesive made by crosslinking a first polymer and a second polymer with a crosslink agent, wherein the glass transition temperature of the first polymer is higher than the glass transition temperature of the second polymer, and the first polymer and the second polymer are miscible in each other.

2. The adhesive of claim 1, wherein the glass transition temperature of the first polymer is between 0 and 150° C.

3. The adhesive of claim 1, wherein the glass transition temperature of the first polymer is between 10° C. and 100° C.

4. The adhesive of claim 1, wherein the glass transition temperature of the first polymer is between 30° C. and 85° C.

5. The adhesive of claim 1, wherein the glass transition temperature of the second polymer is between −100° C. and 0.

6. The adhesive of claim 1, wherein the glass transition temperature of the second polymer is between −80° C. and −10° C.

7. The adhesive of claim 1, wherein the glass transition temperature of the second polymer is between −60° C. and −20° C.

8. The adhesive of claim 1, wherein the first polymer and the second polymer are methyl acrylate polymers.

9. The adhesive of claim 1, wherein the weight percentage of the first polymer is between 0.5% and 50%, and the weight percentage of the second polymer is between 99.5% and 50%.

10. The adhesive of claim 1, wherein the weight percentage of the first polymer is between 1% and 20%, and the weight percentage of the second polymer is between 99% and 80%.

11. The adhesive of claim 1, wherein the crosslink agent is isocyanate.

12. An adhesive manufacturing method, comprising the steps of:
providing a first polymer;
providing a second polymer, wherein the glass transition temperature of the first polymer is higher than the glass transition temperature of the second polymer, and the first polymer and the second polymer are miscible in each other; and
crosslinking the first polymer and the second polymer.

13. The adhesive manufacturing method of claim 12, wherein the glass transition temperature of the first polymer is between 0 and 150° C.

14. The adhesive manufacturing method of claim 12, wherein the glass transition temperature of the first polymer is between 10° C. and 100° C.

15. The adhesive manufacturing method of claim 12, wherein the glass transition temperature of the first polymer is between 30° C. and 85° C.

16. The adhesive manufacturing method of claim 12, wherein the glass transition temperature of the second polymer is between −100° C. and 0.

17. The adhesive manufacturing method of claim 12, wherein the glass transition temperature of the second polymer is between −80° C. and −10° C.

18. The adhesive manufacturing method of claim 12, wherein the glass transition temperature of the second polymer is between −60° C. and −20° C.

19. The adhesive manufacturing method of claim 12, wherein the weight percentage of the first polymer is between 0.5% and 50%, and the weight percentage of the second polymer is between 99.5% and 50%.

20. The adhesive manufacturing method of claim 12, wherein the weight percentage of the first polymer is between 1% and 20%, and the weight percentage of the second polymer is between 99% and 80%.
